(19) United States
(12) Patent Application Publication
(10) Pub. No.: US 2011/0274283 A1
(43) Pub. Date: Nov. 10, 2011

(54) Open Air Noise Cancellation

(76) Inventor: Lewis Athanas, Marblehead, MA (US)

(21) Appl. No.: 12/841,141

(22) Filed: Jul. 21, 2010

Related U.S. Application Data
(60) Provisional application No. 61/227,497, filed on Jul. 22, 2009.

(51) Int. Cl. G10K 11/16

(52) U.S. Cl. 381/71.7; 381/71.1

(57) ABSTRACT

An active noise cancellation device is described that is capable of cancelling an ambient sound wave in an open air environment via destructive interference. The active noise cancellation device comprises a directional microphone, a directional loudspeaker, and a signal processing module. The directional loudspeaker can comprise either one or two dipole loudspeakers in combination with a sealed loudspeaker. Multiple active noise cancellation devices can be arranged in arrays to create open air active noise cancellation systems. Each active noise cancellation device within the array, when combined with the outputs of the other devices within the array, produces a noise cancellation wavefront that actively cancels a portion of an ambient sound wavefront. Arrays of any geometry or spatial dimension are possible.

### CROSS-REFERENCE TO RELATED APPLICATIONS

This application claims the benefit under 35 U.S.C. §119(e) of provisional application 61/227,497, which was filed on Jul. 22, 2009 and is incorporated herein by reference in its entirety.

### BACKGROUND

1. Field of Art

The invention generally relates to noise cancellation, and, more particularly, relates to open air noise cancellation in the time domain.

2. Description of the Related Art

Passive noise control techniques such as earplugs, thick walls, and sound-absorbing ceiling tiles are well known. However, such passive solutions are undesirable for many situations in which noise cancellation or suppression is desired as they can be uncomfortable, bulky, unsightly, or ineffective. More recently, active noise cancellation (ANC) techniques have been developed whereby a speaker emits a sound wave that is designed to cancel out offensive noise via destructive interference.

However, prior active noise cancellation technologies are limited in applicability. They are suitable only for very small enclosed spaces, such as headphones, or for continuous low frequency sounds, such as machinery noise. For example, noise canceling headphones depend upon isolation provided by the headphones and ear canal for stability, and therefore can produce a very unpleasant shrieking noise upon removal as the isolation of the system is disrupted. Also, noise cancellation headphones cannot be used by newborn babies or others who may be sensitive to noise but unable to wear a headphone for physical or medical reasons. Further, due in part to a dependency on complex signal processing algorithms, prior technologies are limited to actively cancelling noise that comprises a small range of predictable frequencies (e.g., relatively steady-state and low-frequency noise).

For these reasons, existing active cancellation techniques are ineffective in many situations where it is desirable to reduce noise, such as in offices, banks, hospitals, outdoor areas near highways or airports, or in and around residences. Accordingly, passive noise reduction (e.g., absorption) is typically used for these situations, but passive approaches have limited bandwidth and, when used incorrectly, can result in acoustically unpleasant conditions, such as an overly damped (“dead”) sounding room.

Thus, passive and currently available active noise cancellation techniques are unsuitable for many situations where noise cancellation is desirable.

### SUMMARY

A first aspect of the invention is an active noise cancellation device capable of cancelling an ambient sound wave or wavefront in an open air environment. In one embodiment, the active noise cancellation device comprises a directional microphone, a directional loudspeaker, and a signal processing module. The directional microphone has a first polar response (e.g., a cardioid polar response) and is configured to produce a microphone output signal in response to a wavefront being incident upon the directional microphone. The microphone output signal is representative of the incident wavefront, which may be a portion of a larger ambient wavefront. The directional loudspeaker has a second polar response (e.g., a cardioid polar response). The directional loudspeaker is spatially positioned such that it faces away from the reception field of the microphone, i.e., the first polar response and the second polar response are opposite in orientation. The signal processing module comprises signal processing means (e.g., analog or digital electronic circuitry) configured to receive the output signal from the directional microphone and transmit a control signal to the directional loudspeaker. The control signal output by the signal processing module causes the directional loudspeaker to produce a noise cancellation wavefront. The noise cancellation wavefront is produced by the directional loudspeaker simultaneously with the ambient sound wavefront reaching the directional loudspeaker, which means the directional loudspeaker produces the noise cancellation wavefront some time after a portion of the ambient sound wavefront is incident upon the microphone. Upon its generation, the noise cancellation wavefront and the ambient sound wavefront are equal in magnitude (e.g., amplitude, intensity, or sound pressure level) and are of inverse (opposite) polarity. Thus, the noise cancellation wavefront actively cancels at least a portion of the ambient sound wavefront via destructive interference.

A further aspect of the invention is a directional loudspeaker suitable for use as a part of an open air active noise cancellation device. In one embodiment, the directional loudspeaker comprises a first loudspeaker and a second loudspeaker. The first loudspeaker has a dipole polar response and the second loudspeaker has an omnidirectional polar response. The first and second loudspeakers are mounted on a common baffle such that the first loudspeaker and the second speaker face the same way, both opening towards a common acoustic half space. The second loudspeaker can be a sealed loudspeaker comprising a driver and an enclosure. The enclosure of the sealed loudspeaker has an internal air volume that combines with the driver of the sealed loudspeaker to form a mechanical high-pass filter. The enclosure can be designed to have a particular internal air volume based on desired characteristics of the resulting mechanical high-pass filter. Also, in one embodiment, the first loudspeaker is coincident with the second loudspeaker. The first loudspeaker is also bass-boosted such that the first and second loudspeakers having matching frequency responses over a desired operational frequency range, the operational frequency range dependent upon the particular deployment of an open air active noise cancellation device or system. Other embodiments of the directional loudspeaker comprise three loudspeakers: two having a dipole polar response and one having an omnidirectional polar response. All three loudspeakers are mounted on a common baffle such that they are substantially collinear (e.g., the center points of the drivers for all three loudspeakers are collinear) and the omnidirectional loudspeaker spatially intervenes between the two dipole loudspeakers.

Another aspect of the invention is a system or apparatus for actively cancelling an ambient sound wavefront in an open air environment that comprises a plurality of active noise cancellation devices arranged in an array. Each active noise cancellation device in the system is configured to produce a noise cancellation wavefront that cancels at least a portion of the ambient sound wavefront via destructive interference. In accordance with the Huygens principle, the plurality of noise cancellation wavefronts created by the array combine to actively cancel either the entirety or a substantial portion of the ambient sound wavefront. Each active noise cancelation device in the system comprises a directional microphone, a directional loudspeaker, and a signal processing module. The directional microphone has a first polar response (e.g., a cardioid polar response) and is configured to produce a microphone output signal representative of any ambient sound wave incident upon the directional microphone. The directional loudspeaker has a second polar response (e.g., a cardioid polar response). The directional loudspeaker is spatially positioned such that it faces away from the reception field of the microphone, i.e., the first polar response and the second polar response are opposite in orientation. The signal processing module comprises signal processing means (e.g., analog or digital electronic circuitry) configured to receive the output signal from the directional microphone and transmit a control signal to the directional loudspeaker. The control signal output by the signal processing module causes the directional loudspeaker to produce a noise cancellation wavefront. The noise cancellation wavefront is produced by the directional loudspeaker simultaneously with the ambient sound wavefront reaching the directional loudspeaker, which means the directional loudspeaker produces the noise cancellation sound wave some time after a portion of the ambient sound wavefront is incident upon the microphone. Upon its generation, the noise cancellation wavefront and the corresponding portion of the ambient sound wavefront are equal in magnitude (e.g., amplitude or sound pressure level) and are of inverse (opposite) polarity. Thus, the noise cancellation sound wavefront actively cancels the corresponding portion of the ambient sound wave via destructive interference. Again, in accordance with the Huygens principle, the plurality of noise cancellation wavefronts created by the array combine to create an accurate duplicate of the ambient sound wavefront whose waveform is an inverse of the ambient sound waveform.

The plurality of active noise cancellation devices in a system or actively cancelling an ambient sound wave in an open air environment can be located in a wide variety of spatial arrangements (one-dimensional, two-dimensional, or three-dimensional arrays of active noise cancellation devices) for a wide variety of applications and deployments. In fact, arrays and spatial arrangements are customizable depending on the spatial and frequency characteristics of noises to be cancelled and environments in which the benefits of noise cancellation are desired. For example, noise cancellation devices can be arranged as a line array (any “string” or “row” of devices which can follow either a straight line or a line any degree of curvature). Devices within the array can be arbitrarily and non-uniformly spaced. In some applications, the plurality of active noise cancellation devices can be arranged atop or wall or around the perimeter of an area and can be oriented in any direction (i.e., noise can be actively canceled from the perspective of either side of the wall or perimeter such that noise is either actively canceled from escaping the area or from entering the area). The plurality of active noise cancellation devices can also be mounted to any manner of structural frame, such as a mobile chassis, to prevent noise either from escaping or penetrating a volume enclosed by the structural frame.

A system or apparatus for actively cancelling an ambient sound wave in an open air environment that comprises a plurality of active noise cancellation devices can also employ crosstalk cancellation to reduce, minimize, or negate any effect upon the operation of an individual active noise cancellation device due to the noise cancellation waves produced by other active noise cancellation devices within the system. In one embodiment, employing crosstalk cancellation comprises receiving a cross-talk cancellation signal from one or more neighboring noise cancellation device, where the cross-talk cancellation signal is representative of sound produced by the neighboring noise cancellation device. For example, by mixing the output of an individual noise cancellation device's microphone with an appropriately time-delayed and inverted version of the microphone outputs of neighboring cells, the signal processing module of the individual noise cancellation device can remove undesired influence of neighboring devices.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

FIG. 1 illustrates a spatial arrangement of two noise sources.

FIG. 2 illustrates recreation of a wavefront by a plurality of point sources.

FIG. 3 illustrates one embodiment of a noise cancellation array.

FIG. 4A illustrates a cross-section of one embodiment of an active noise cancellation cell.

FIG. 4B illustrates polar responses for different types of loudspeakers.

FIG. 4C illustrates theoretical frequency responses for different types of loudspeakers.

FIG. 4D illustrates a cross-section of another embodiment of an active noise cancellation cell.

FIG. 5 illustrates one embodiment of a signal processing module.

FIG. 6 illustrates one embodiment of a noise cancellation array that implements crosstalk cancellation.

FIGS. 7A and 7B show an embodiment of a system employing open air noise cancellation in accordance with the present invention.

FIGS. 8A and 8B show another embodiment of a system employing open air noise cancellation in accordance with the present invention.

FIG. 9 shows another embodiment of a system employing open air noise cancellation in accordance with the present invention.

The figures depict various embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

### Conceptual Overview

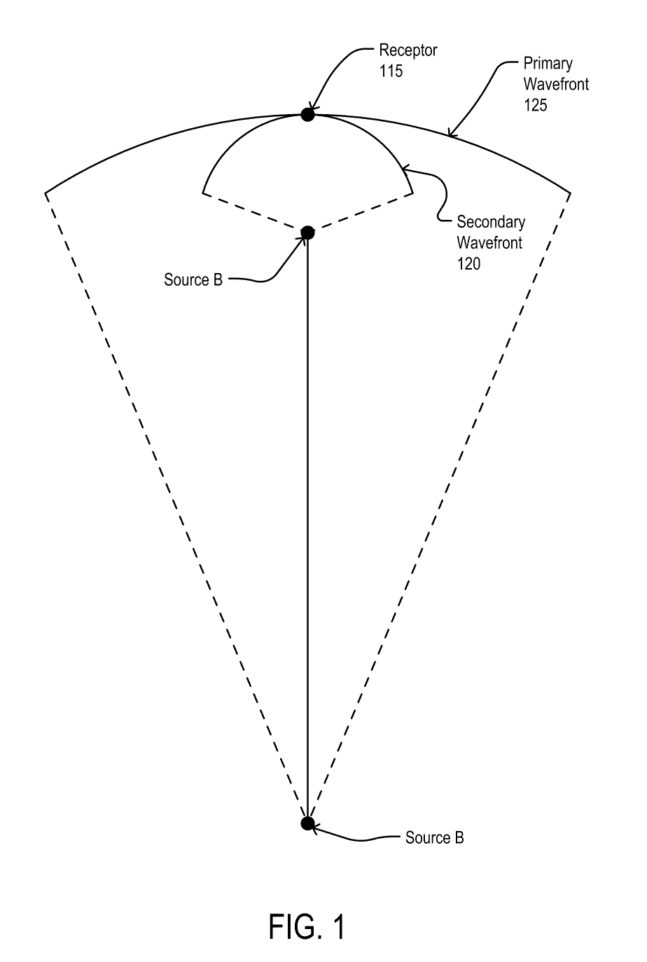

Active cancelation of ambient noise is provided by an array of individual noise cancelation devices. Among other advantages, the techniques and devices described herein provide active noise cancellation in the time domain and are capable of cancelling an offending noise source in an open air environment. As a basis for explaining the principles of operation for the methods and devices described herein, FIG. 1 illustrates a spatial arrangement of two noise sources, source A and source B, along with a noise receptor 115. Source A generates a primary wavefront 125, and source B generates a secondary wavefront 120.

If source A is a point source, the primary wavefront 125 travels away from source A with equal amplitude and velocity characteristics in all directions, creating a spherical wavefront centered at source A. The primary wavefront 125 is a portion of such a spherical wavefront. The amplitude of the primary wavefront 125 decreases as the primary wavefront 125 travels further from source A due to the inverse square law. At any particular point away from source A, such as the location of the receptor 115, the primary wavefront 125 will therefore have an associated location-specific amplitude, time delay (elapsed time between generation of the primary wavefront 125 and the primary wavefront 125 reaching the location, e.g., the location of the receptor 115), and curvature. Similarly, if source B is a point source, the secondary wavefront 120 will also reach the receptor 115 with an associated amplitude, time delay, and curvature.

The secondary wavefront 120 will actively cancel the primary wavefront 125 at the location of the receptor 115 via destructive interference if two conditions are satisfied. The first condition is that the amplitude of the secondary wavefront 120 at the receptor 115 is equal in magnitude but opposite in polarity to the amplitude of the primary wavefront 125 at the receptor (i.e., the amplitude of the secondary wavefront 120 must be the inverse of that of the primary wavefront 125). An alternative, manner of stating this first condition is that the primary wavefront 125 and secondary wavefront 120 must be of equal intensity or sound pressure level (SPL) and of opposite or inverse polarity. The second condition is that the primary wavefront 125 and the secondary wavefront 120 reach the location of the receptor 115 simultaneously. This will occur if source B is configured to generate the secondary wavefront 120 at the time that the primary wavefront 125 crosses source B, as both wavefronts 120, 125 will thereafter arrive at the receptor 115 at the same time. Similarly, the secondary wavefront 120 will satisfy the first condition if, upon its generation by source B, it is inverse in amplitude to that of the primary wavefront 125 at the location of source B as both waves 120, 125 will decay in amplitude by an equal amount between source B and the receptor 115.

However, even if source B is configured such that both of the above-described conditions are satisfied, complete cancellation will only occur at the precise location of the receptor 115. As source A and source B are located at different distances and angles from the receptor 115, the radii of the two wavefronts 120, 125 and therefore their curvatures will differ at the receptor 115 location. Due to this disparity in curvature, the amplitudes and timed delays for the two wavefronts 120, 125 will not coincide at any location other than the receptor 115, as illustrated in FIG. 1. Thus, in an open air environment where noises are generated from multiple different sources at various distances and angles relative to a listener, a single secondary point source can only provide full active noise cancellation of another remote point source at a single point in space.

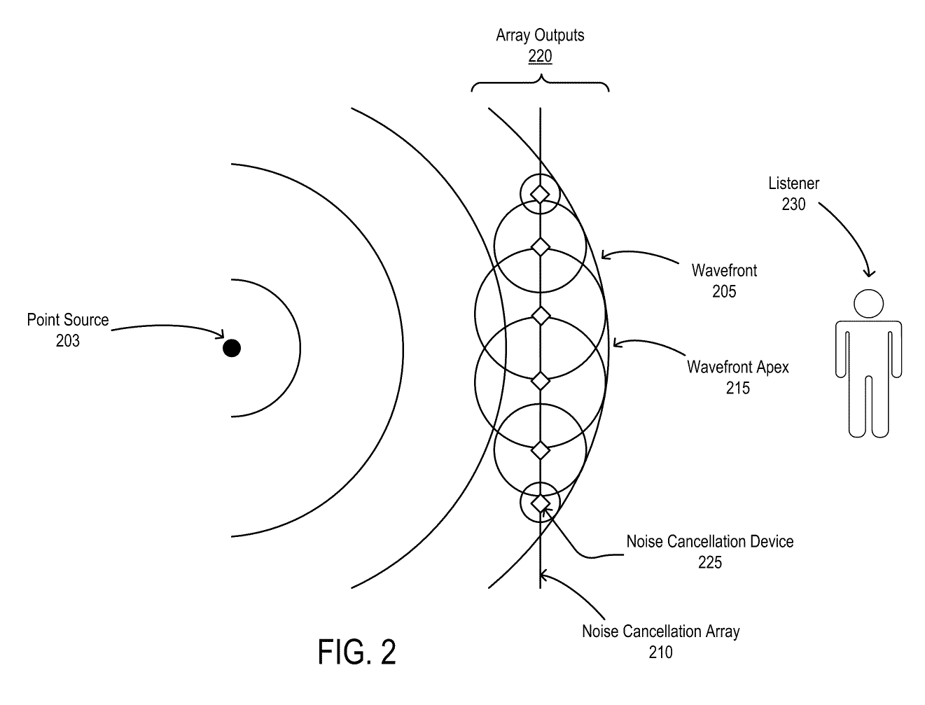

In contrast, an array of secondary point sources in accordance with the embodiments described herein can take advantage of Huygens principle of wavefront reconstruction to provide vastly improved active noise cancelation of a remote source in an open air environment, whether the remote source is a single point source or any other type of source. As illustrated by FIG. 2, from the perspective of a listener 230, an ambient wavefront 205 in an open air environment can be actively cancelled in the time domain by a plurality of intervening noise cancellation devices 225 whose outputs vary temporally with respect to amplitude and time delay (alternatively referred to as phase). In FIG. 2, the ambient wavefront 205 is generated by a point source 203 and therefore has a circular shape. To the right of the point source 203, a noise cancellation array 210 of noise cancellation devices 225 is positioned between the point source 203 and a listener 230. The noise cancellation devices 225 produce a plurality of circular outputs 220. The array 210 is shown here as linear array of noise cancellation device 225 arranged in substantially straight line. If the noise cancellation devices 225 within the array 210 are configured to produce outputs 220 with appropriate amplitudes and time delays, the linear array 210 can actively cancel any noise associated with the wavefront 205 at all locations to the right of the linear array 210 because the array outputs 220 will combine to collectively cancel the ambient wavefront 205 in accordance with Huygens principle of wavefront reconstruction.

Because distance from the point source 203 varies along the linear array 210, the circular wavefront 205 crosses different point sources within the linear array 210 at different times as it travels from left to right. Specifically, the wavefront apex 215 crosses the array 210 first. Thus, to actively cancel the ambient wavefront 205, point sources 210 located nearest the crossing point of the wavefront apex 215 produce their outputs 220 first, and the relative time delay increases for the outputs 220 of each other noise cancellation device 225 in proportion to the distance from that noise cancellation device 225 to the crossing point of the wavefront apex 215. The amplitude of the ambient wavefront 205 also varies as it crosses different point sources within the linear array 210. The closer a noise cancellation device 225 within the linear array 210 is to the crossing location of the wavefront apex 215, the greater the amplitude must be of its inverse output 220 in order to provide proper open air noise cancellation.

For the sake of illustrative clarity, FIG. 2 shows only a limited number of outputs 220 for the array 210. Nevertheless, FIG. 2 clearly illustrates that decreasing the separation between the noise cancellation devices 225 within the array 210 allows for outputs 220 that, in the aggregate, represent an inverse version of the wavefront 205 with increasing precision. Hence, the extent to which the array 210 actively cancels the ambient wavefront 205 for all locations to the right of the array 210 is directly proportional to the density of noise cancellation devices 225 within the array 210.

The embodiments described herein are largely agnostic to the angular location of the remote source to be cancelled and to the shape of any associated wavefronts. However, the extent to which an offending noise is actively cancelled can vary as a function of (i) the distance separating the offending noise source and the array 210 and (ii) the distance separating noise cancellation devices 225 within the array 210.

Though the embodiments described herein provide active noise cancellation in the time domain, frequency domain concepts can still be illustrative. In the frequency domain, active noise cancellation represents the addition of noise that is 180° out of phase with the original noise. An offending noise source that generates noise that is too high in frequency, an offending noise source that is located too close to the array 210, or an array 210 that is too close to the listener 230, can result in the perceived addition of noise that is not fully 180° out of phase with the original noise, resulting in either reduced cancellation or, in the extreme, even increased intensity (as measured in terms of sound pressure level) of ambient noise. For example, whereas the addition of equal-intensity noise that is 180° out of phase with the original noise results in total cancellation, the addition of equal-intensity noise that is 150° out of phase with the original noise results in only −6 dB of cancellation (as used herein, −6 dB of cancellation implies a 6 dB reduction in perceived noise). As another example, the addition of equal-intensity noise that is 165° out of phase with the original noise results in −12 dB of cancellation. Mathematically, the effective sound reduction achieved by an array 210 of noise cancellation devices 225 can be represented by the following design equation:

$${f}_{- 6} = \frac{345}{12 * ( \sqrt{( {D}^{2} + {( \frac{s}{2} )}^{2}} - D )}$$

In the above equation, D represents distance to between the offending noise source and the nearest point of the array 210 in meters, and S represents the distance between noise cancellation devices 225 within the array 210 in meters. f₋₆ represents the maximum frequency of offending noise for which the array 210 can achieve −6 dB of cancellation, and is referred to herein as either the −6 dB frequency or 6 dB cancellation frequency. The above design equation applies equally to two-dimensional as well as one-dimensional (linear) arrays 210.

If an offending noise source outputs an ambient wavefront 205, the array 210 reduces perceived noise associated with the wavefront by more than 6 dB for all frequency components of the wavefront 205 that are below the −6 dB frequency. On the other hand, for components of the ambient wavefront 205 that are above the −6 dB frequency, the array 210 reduces associated noise by an amount less than 6 dB. This decrease in effectiveness at frequencies above the −6 dB frequency can result in comb filtering (sometimes referred to informally as “picket fencing”). Rather than achieving total cancellation of the ambient wavefront 205 produced by the offending noise source 203, comb filtering introduces alternating minima and maxima of cancellation along the array 210. Particularly, higher frequency components of the offending noise source's output can be undesirably perceived by the listener 230 on the opposite side of the noise cancellation array 210. At the −6 dB frequency, a listener 230 moving laterally along the array 210 will perceive alternating locations of full cancellation, −6 dB cancellation, full cancellation, etc. Accordingly, as described in greater detail below, embodiments of the array 210 comprise a plurality of open air noise cancellation devices 225 (referred to hereinafter as “cells”) that are separated from other devices 225 in the array 210 based on parameter S in the above design equation, and from the offending noise source 230 based on parameter D in the above design equation so as to give a desired level of active noise cancellation given the frequency characteristics of the offending source's output.

FIG. 2 illustrates open air active noise cancellation principles as implemented by a linear array 210 of noise cancellation devices 225, but the principles are equally applicable in three dimensions as well, given that wavefronts are spherical in nature, and thus apply to embodiments where the array 210 is a two-dimensional spatial array (e.g., a two-dimensional planar grid/array of noise cancellation devices 225). The concept that an appropriately dense array 210 of noise cancellation devices 225 whose respective outputs have appropriately varied time delay and amplitude characteristics can provide active noise cancellation in an open air environment from the perspective of one side of the array 210 applies to any manner of wavefront that crosses the array 210, regardless of the nature of the wavefront's source or shape and regardless of the particular geometry of the array 210.

### System Overview

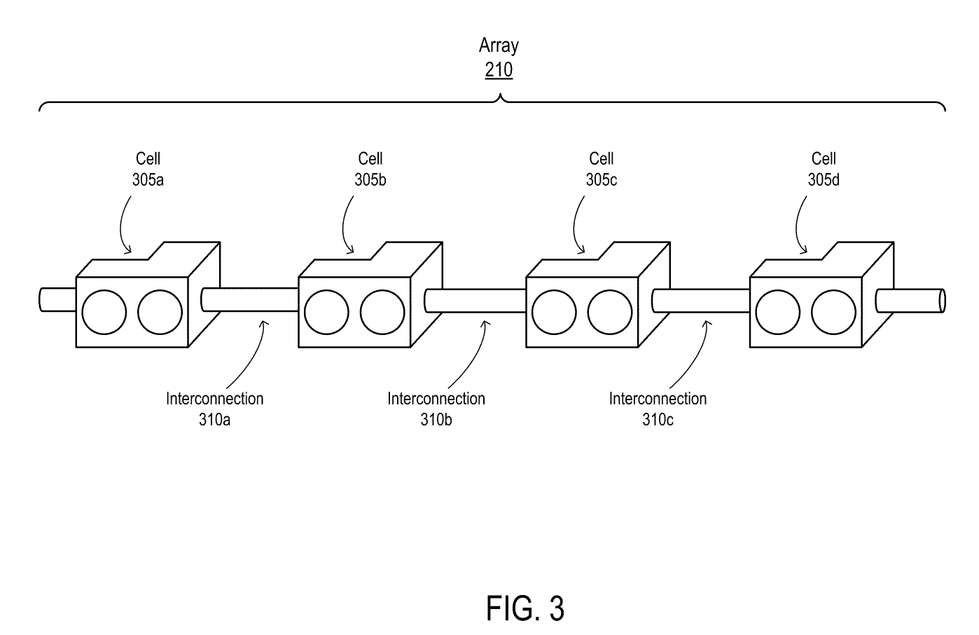

FIG. 3 illustrates one embodiment of a noise cancellation array 210. The array 210 comprises a plurality of cells 305 that are coupled by a plurality of interconnections 310. Each cell 305 comprises a noise cancellation device. For the sake of visual clarity, FIG. 3 depicts four cells 305 and three interconnections 310, but it is to be appreciated that various embodiments of arrays 210 could comprise any number of cells 305 or interconnections 310. Also, FIG. 3 depicts a one-dimensional (i.e., linear) array 210 of cells 305, but two-dimensional and three-dimensional arrays 210 of cells 305 are also possible. Curved arrays 210 are also possible. For example, a linear array 210 can comprise cells 305 that are arranged and spaced along a curved line. Similarly, a two-dimensional array 210 can be either a planar array 210 or comprise cells 305 whose placements conform to or create an undulating surface.

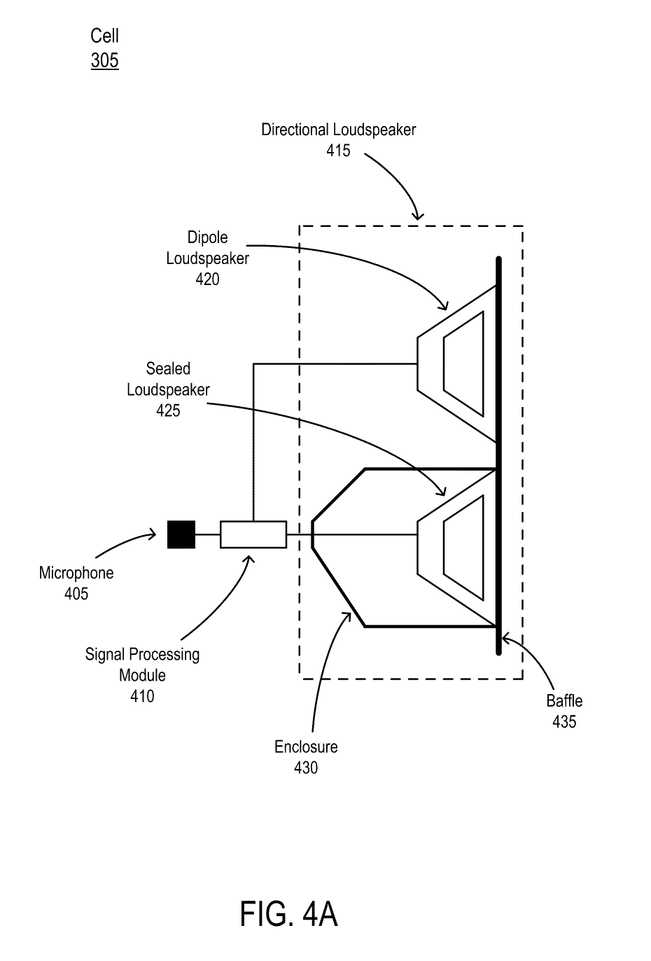

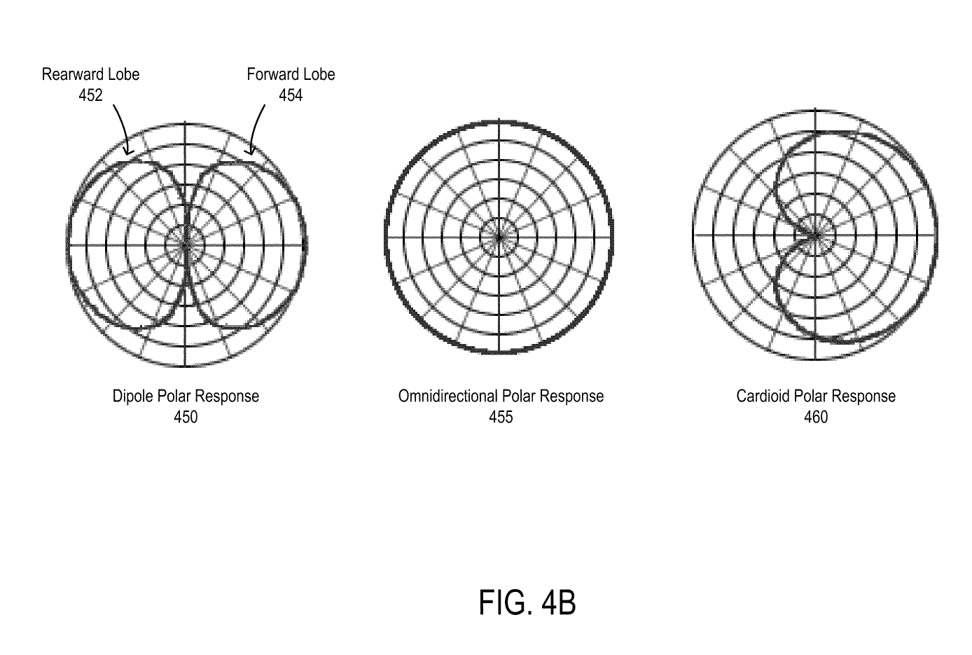

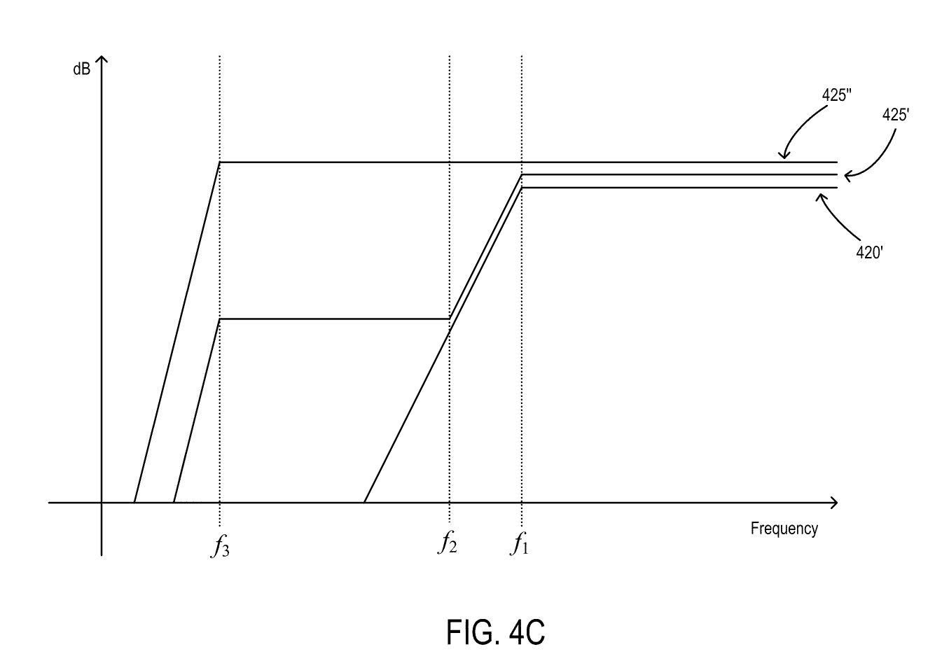

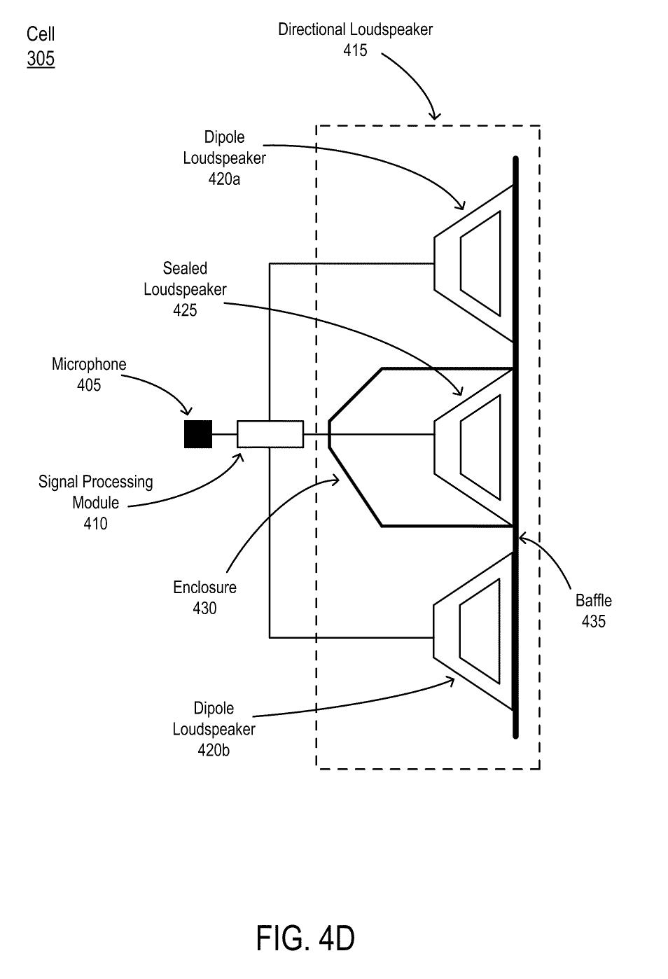

In accordance with the general principles described above with respect to FIG. 2, each cell 305 is configured to produce an output having a particular amplitude and time delay such that the outputs of the cells 305 of the array 210 cumulatively provide active noise cancellation of any wavefront which crosses the array 210. The design and operation of various embodiments of a cell 305 are described in further detail below with respect to FIGS. 4A-4D.

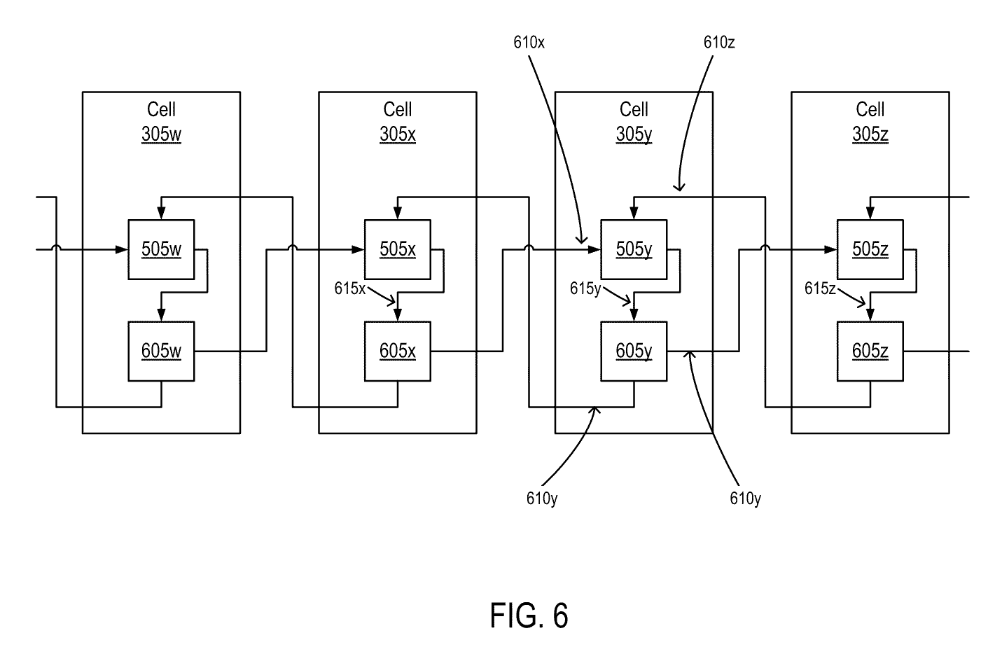

Many embodiments of interconnections 310 are possible. In one embodiment, an interconnection 310 comprises wires or other means for providing power to one or more cells 305. In some embodiments, an interconnection 310 comprises wiring and circuitry that couples multiple cells 305 and that also passes signals between the cells 305 for cross-talk cancellation between the coupled cells 305. Further details of embodiments that include cross-talk cancellation are provided below with respect to FIG. 6. In some embodiments, interconnections 310 comprise either rigid supporting material or rigid enclosing material (e.g., rigid plastic pipe) such that cells 305 are maintained in a specific geometric alignment.

In some embodiments, the cells 305 are secured in placed without relying on interconnections 310 for structural support or rigidity for the array 210. In these embodiments, the cells 305 are rigidly attached to a surface such as a wall, floor, ceiling, rail, shelf, ledge, fence, post, or other object as desired. Power can be supplied to such a cell 305 by connection to a utility grid, by one or more batteries, by connection to one or more photovoltaic cells, or by connection to any other power source suitable for the power requirements and location of the cells 305 of the array 210; in this case, the cells 305 can be wired for power individually or jointly.

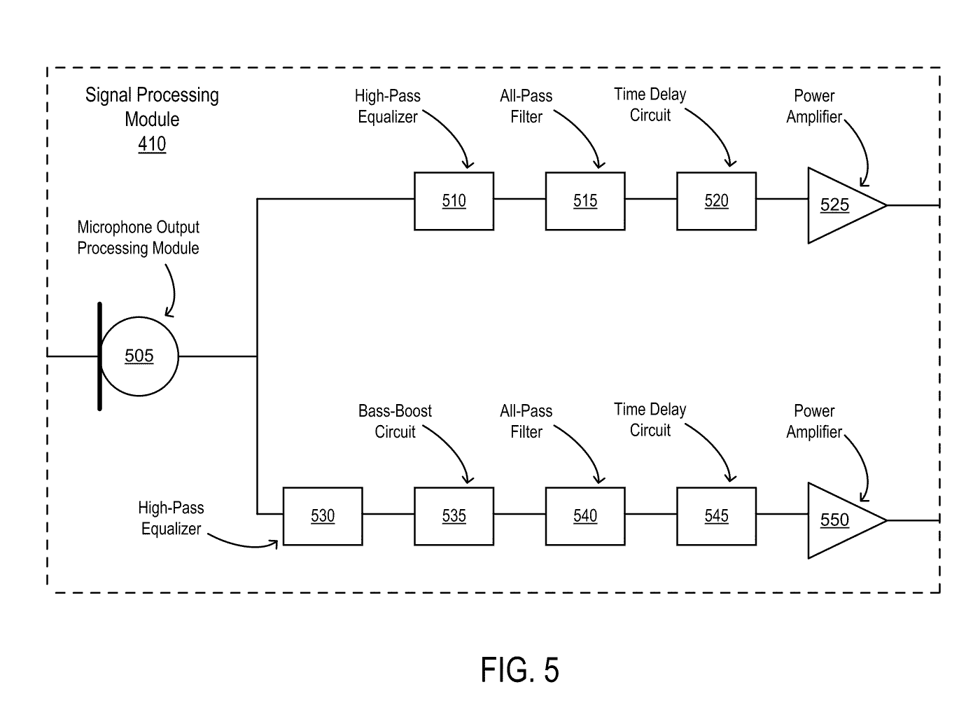

FIG. 4A illustrates a cross-section of one embodiment of a cell 305. The cell 305 comprises a microphone 405, a signal processing module 410, and a directional loudspeaker 415. The signal processing module 410 is communicatively coupled to the microphone 405 and to the directional loudspeaker 415. The signal processing module 410 receives electrical input signals generated by the microphone 405 and outputs electrical control signals to govern the output of the directional loudspeaker 415 (e.g., control signals for driving any speaker driver included in the directional loudspeaker 415). Further details of the signal processing module 410 are provided below in reference to FIG. 5.

In one embodiment, the microphone 405 is a unidirectional microphone. For example, the microphone 405 can be a directional (unidirectional) microphone with a cardioid polar response such as the model WM-55A103 microphone produced by the Panasonic Corporation. The microphone 405 can therefore comprise a 2π steradian receiver. The directional loudspeaker 415 provides a substantially unidirectional response, e.g., a cardioid response. The directional loudspeaker 415 can therefore comprise a 2π steradian radiator. However, the directional loudspeaker 415 is laterally separated from the microphone 405 by a distance and is oriented such that its unidirectional polar response faces away from (is diametrically opposite of) that of the microphone 405. The loudspeaker 415 can be placed substantially behind the microphone 405 (the separation distance is, however, application-specific and can be very small in some embodiments and large in other embodiments). In one embodiment, the microphone 405 and the directional loudspeaker 415 are coincident. The microphone 405 and the directional loudspeaker 415 are physically so positioned to be within each other's acoustic shadow, affording acoustic separation between the microphone 405 and the directional loudspeaker 415 on the order of tens of decibels. Hence, under normal operating conditions, the cell 305 is incapable of becoming unstable and oscillating. This, combined with the unidirectional nature of both the microphone 405 and the directional loudspeaker 415, ensures that undesirable instability and acoustic feedback (sometimes referred to as “shriekback”) is avoided. Along with also having a unidirectional response, the directional loudspeaker 415 is configured such its frequency response matches that of the microphone 405 as nearly as possible. It is preferred that both the microphone 405 and the directional loudspeaker 415 have similar cardioid polar responses and approximately identical frequency responses.

In one embodiment, the directional loudspeaker 415 is physically small relative to the wavelength of the noise being cancelled. As a general rule, a loudspeaker is directional with respect to a particular wavelength if the effective diameter of the loudspeaker (which includes any baffle on which the loudspeaker is mounted) is comparable to or larger than the particular wavelength. Hence, to be directional for frequencies as low as 250 Hz, a typical loudspeaker must have an effective diameter of at least seventeen inches, and therefore an effective area in excess of two-hundred and twenty-seven square inches. Such large dimensions required by typical low-frequency directional loudspeakers, are undesirable for many active noise cancellation applications. However, the embodiments described herein are beneficially capable of providing a directional loudspeaker 415 that maintains directionality for frequencies as low as the directional loudspeaker 415 is capable of playing with no dependency upon an effective cross-sectional area. For example, one embodiment of the directional loudspeaker 415 comprises two separate one-inch-diameter drivers mounted on a minimally sized baffle.

In the cell 305 illustrated by FIG. 4A, the directional loudspeaker 415 comprises a dipole loudspeaker 420, a sealed loudspeaker 425, an enclosure 430 for the sealed loudspeaker 425, and a baffle 435. The dipole loudspeaker 420 and the sealed loudspeaker 425 are coincident and both mounted on the baffle 435. The dipole loudspeaker 420 and the sealed loudspeaker 425 face the same direction, with the drivers of both opening towards the same half space (2π steradian space). In one embodiment, the driver of the dipole loudspeaker 420 and the driver of the sealed loudspeaker 425 are equal in diameter and are separated on the baffle 435 by a distance that is less than half of the driver diameter.

Together, the coincident dipole loudspeaker 420 and sealed loudspeaker 425 produce a unidirectional cardioid output. As illustrated in FIG. 4B, the dipole loudspeaker 420 produces an output whose polar response 450 comprises a rearward lobe 452 and a forward lobe 454 and therefore resembles a figure eight. The rearward lobe 452 and the forward lobe 454 are equal in intensity (i.e., both lobes 452, 454 have amplitudes that are equal in magnitude). However, the rearward lobe 452 of the dipole polar response is 180 degrees out of phase with the forward lobe 454. This is because the two lobes 452, 454 are produced by forward and reverse movements of the same speaker driver. Thus, when the dipole loudspeaker 420 is coincident with the sealed loudspeaker 425, if the drivers of the dipole loudspeaker 420 and sealed loudspeaker 425 are synchronized, the rearward lobe 452 of the dipole polar response 450 destructively interferes with corresponding portions of the omnidirectional polar response 455 of the sealed loudspeaker 425. Hence, if the rearward lobe 452 of the dipole loudspeaker 420 output is also equal in intensity to the omnidirectional output of the sealed loudspeaker 425, the directional loudspeaker 415 has a cardioid polar response 460. In some embodiments, acoustically absorptive material is applied to the backside of the dipole loudspeaker 420 or the sealed loudspeaker 425 to properly match their respective polar and frequency responses.

In one embodiment, both the dipole loudspeaker 420 and the sealed loudspeaker 425 comprise a speaker driver that is one inch in diameter, such as the model W1-1070SE full-range driver produced by the Tang Band company. A suitable driver has an accurate frequency and phase response (i.e., exhibits minimum-phase behavior and an absence of sharp changes or discontinuities in the passband frequency range). Such characteristics enable a driver to accurately pass a complex waveform and allow for simplification of the signal processing module 410 (e.g., less complex equalization is required for the directional loudspeaker 415).

The enclosure 430 for the sealed loudspeaker 425 combines with the driver of the sealed loudspeaker to create a mechanical high-pass filter that (i) has a sufficiently low cutoff frequency to provide cancellation in the frequency range required by a particular application and (ii) exhibits minimal frequency peaking and rolloff at the resonant frequency. In one embodiment, the enclosure 430 is therefore sized to have an internal air volume based on several relevant parameters of the driver for the sealed loudspeaker 425, including the moving mass, spring constant/coefficient, spring rate, and electromechanical coupling characteristics of the driver. The internal air volume of the enclosure 430, in conjunction with the relevant parameters of the driver for the sealed loudspeaker 425, determines the characteristics of the resulting mechanical high-pass filter.

In one embodiment, the baffle 435 is as physically small as possible. The baffle 435 is large enough to accommodate any drivers included in the directional loudspeaker 415 (e.g., a first one-inch driver for the dipole loudspeaker 420 and a second one-inch driver for the sealed loudspeaker 425), but is otherwise sized so as to provide minimal interference with any sound fields in the vicinity of the cell 305.

FIG. 4C schematically illustrates the theoretical frequency response of several types of loudspeakers. Specifically, FIG. 4C illustrates the theoretical frequency response 420′ of a dipole loudspeaker suspended in space, the theoretical frequency response 425′ of a sealed loudspeaker suspended in space, and the theoretical frequency response 425″ of a sealed loudspeaker with an infinite baffle. The theoretical frequency response curves of FIG. 4C provide information that can be used to design various embodiments of a directional loudspeaker 415 in accordance with the teachings herein. The theoretical frequency response 420′ of a dipole loudspeaker suspended in space can serve as a model for the frequency response of a dipole loudspeaker 420. Similarly, the theoretical frequency response 425′ of a sealed loudspeaker suspended in space can serve as a model for the frequency response of a sealed loudspeaker 425. The response curves 420′, 425′, 425″ are slightly offset in the upper frequency bands for visual clarity.

Each loudspeaker has a rolloff frequency below which output of the loudspeaker decreases in intensity. Assuming that dipole loudspeaker 420 and the sealed loudspeaker 425 have drivers that share the same baffle 435, the output of the dipole loudspeaker 420 and the sealed loudspeaker 425 can be expected to decline below a baffle dimension frequency f₁ as illustrated in FIG. 4C. This decline is at a rate of 6 dB per octave. The baffle dimension frequency f₁ occurs when the wavelength of the sound output by the dipole loudspeaker 420 and the sealed loudspeaker 425 transitions from smaller than the cross section of the shared baffle 435 to larger than the cross section of the shared baffle 435.

However, below a 4π steradian frequency f₂, the output of the dipole loudspeaker 420 continues to decline at a rate of 6 dB per octave while the output of the sealed loudspeaker 425 stops declining. The 4π steradian frequency f₂ occurs when the wavelength of the generated sound becomes sufficiently larger than the baffle 435 that the sealed loudspeaker 425 transitions from a half space output (2π steradians) to a full space output (4π steradians). The output of the dipole loudspeaker 420 continues to roll off at 6 dB per octave as frequency decreases due to the absence of an enclosure 430 to isolate the negative rear radiation of its driver (i.e., the rearward lobe 452) from the frontward lobe 454.

The output of the sealed loudspeaker 425, on the other hand, will remain approximately constant below the 4π steradian frequency f₂ until a system resonant frequency f₃. In one embodiment, the system resonant frequency f₃ corresponds to the natural resonant frequency of the sealed loudspeaker 425. Thus, below the system resonant frequency f₃, the output of the sealed loudspeaker 425 declines at a rate of 12 dB per octave. Because the natural resonant frequency of the dipole loudspeaker 420 is dictated by the free air parameters of the driver of the dipole loudspeaker 420, the natural resonant frequency of the dipole loudspeaker 420 is inherently lower than the natural resonant frequency of the sealed loudspeaker 425. Hence, one embodiment of the signal processing module 410 is configured to match the frequency response of the dipole loudspeaker 420 to the frequency response of the sealed loudspeaker 425 by, via appropriate equalization and filtering means, causing the dipole loudspeaker 420 to experience an induced rolloff of 12 dB per octave at frequencies below the system resonant frequency f₃.

A primary takeaway from the curves 420′, 425′, 425″ of FIG. 4B is that, assuming equal driver characteristics, the dipole loudspeaker 420 will have a reduced output compared to the sealed loudspeaker 425 at low frequencies (e.g., frequencies near or below the first rolloff frequency f₁). Hence, in order to obtain the directional loudspeaker 415 of FIG. 4A utilizing the principals described above in reference to FIG. 4B, one embodiment of the dipole loudspeaker 420 is bass-boosted. However, bass-boosting of the dipole loudspeaker 420 is limited to frequencies above the natural resonant frequency f₃ of the sealed loudspeaker 425 in order to match the frequency responses 420′, 425′ of both types of loudspeakers 420, 425, below the natural resonant frequency f₃ of the sealed loudspeaker 425. A multitude of techniques (e.g., equalization and bass-boosting techniques) suitable for matching the frequency response of the dipole loudspeaker 420 to that of the sealed loudspeaker 425 can be used.

FIG. 4D illustrates a cross-section of one alternative embodiment of a cell 305. In the embodiment of FIG. 4D, the directional loudspeaker 415 includes a second dipole loudspeaker 420b. The second dipole loudspeaker 420B is coincident with the first dipole loudspeaker 420a and the sealed loudspeaker 425. All three loudspeakers 420a, 420b, 425 share the baffle 435 and are collinear. The two dipole loudspeakers 420a, 420b are symmetrically arranged on opposite sides of the sealed loudspeaker 425.

In the embodiment of FIG. 4D, driving each of the two dipole loudspeakers 420a, 420b at the same power level as the sealed loudspeaker 425 will result in a total dipole output that is +6 dB compared to the output of the sealed loudspeaker 425. However, in one embodiment, each of the dipole loudspeakers 420a, 420b is operated at half-power relative to the sealed loudspeaker 425, equalization of each loudspeaker 420a, 420b, 425 such that they have matching frequency responses can extend proper low-frequency performance of the directional loudspeaker 415 by one octave relative to the embodiment of FIG. 4A. If appropriate for a particular application, further equalization of the dipole loudspeakers 420a, 420b and the sealed loudspeaker 425 can further extend the low-frequency performance of the directional loudspeaker 415 of FIG. 4D by an additional octave. Also, in some embodiments, acoustically absorptive material is applied to the backside of the dipole loudspeakers 420a, 420b or the sealed loudspeaker 425 to properly match their respective polar and frequency responses.

FIG. 5 illustrates one embodiment of a signal processing module 410. The signal processing module 410 comprises signal processing means (e.g., electric circuits) for performing a variety of signal processing functions within an individual cell 305 to control the output of the directional loudspeaker 415 in accordance with the principles outlined above in reference to FIGS. 1 through 4D. In one embodiment, the signal processing module 410 comprises a microphone output processing module 505, a high-pass equalizer 510 for the sealed loudspeaker 425, an all-pass filter 515 for the sealed loudspeaker 425, a time delay circuit 520 for the sealed loudspeaker 425, and a power amplifier 525 for the sealed loudspeaker 425. The signal processing module 410 also comprises a high-pass equalizer 530 for the dipole loudspeaker 420, a bass-boost circuit 535 for the dipole loudspeaker 420, an all-pass filter 540 for the dipole loudspeaker 420, a time delay circuit 545 for the dipole loudspeaker 420, and a power amplifier 550 for the dipole loudspeaker 420. The signal processing module 410 can also comprise additional versions of any of the elements depicted in FIG. 5 (e.g., one high-pass equalizer 530, one bass-boost circuit 535, one all-pass filter 540, one time delay circuit 545, and one power amplifier 550 for each dipole loudspeaker 420 included in a cell 305).

The microphone output processing module 505 is communicatively coupled to the output of the microphone 405 and receives an electrical signal generated by the microphone 405. The microphone output processing module 505 comprises amplification means, equalization means, and phase adjustment means for matching the microphone 405 to the ambient environment in which the cell 305 is deployed. In one embodiment, the microphone output processing module 505 comprises means for inverting the electrical signal output by the microphone 405. The microphone output processing module 505 generates an electrical signal that is received by both the high-pass equalizer 510 for the sealed loudspeaker 425 and the high-pass equalizer 530 for the dipole loudspeaker 420.

The high-pass equalizer 510 comprises means for filtering electrical signals to filter out low-frequency components of the signal received from the microphone output processing module 505 and transmits the filtered version to the an all-pass filter 515 for the sealed loudspeaker 425. In one embodiment, the cutoff frequency of the high-pass equalizer 510 is based on the lowest frequency of interest for a particular deployment (e.g., the lowest frequency for which open air active noise cancellation in the time domain is desired). The cutoff frequency of the high-pass equalizer 510 can also be based on the maximum amplitude output of the directional loudspeaker 415 for the particular deployment.

The all-pass filter 515 comprises means for adjusting the phase of the electrical signal received from the high-pass equalizer 510. The all-pass filter 515 adjusts the phase as needed to ensure that the cell 305 exhibits a flat frequency and phase (timing) response over its entire operating range. The all-pass filter 515 also outputs the adjusted-phase signal to the time delay circuit 520 for the sealed loudspeaker 425.

The time delay circuit 520 for the sealed loudspeaker 425 comprises means for delaying the propagation of an electrical signal from the microphone output processing module 505 to the power amplifier 525 for the sealed loudspeaker 425. To achieve proper active noise cancellation of a sound wavefront that crosses the microphone 405, the corresponding output of the directional loudspeaker 415 is temporally synchronized with that wavefront's crossing of the plane in which the output of the directional loudspeaker 415 is produced. However, because the microphone and the coincident dipole loudspeaker 420 and sealed loudspeaker 425 are separated by a finite distance (e.g., a few inches), a wavefront that traverses the cell 305 will cross the plane in which the output of the directional loudspeaker 415 is produced some time after it crosses the microphone 405. This particular amount of time can be calculated given the physical dimensions of the cell 305 and the speed of travel for the wavefront. The time delay circuit 520 is configured to delay the propagation of any electrical signal from the microphone output processing module 505 to the power amplifier 525 for the sealed loudspeaker 425 such that any output of the sealed loudspeaker 425 is temporally synchronized with the wavefront that caused the signal to be generated by the microphone 405. Also, some embodiments of the time delay circuit 520 introduce slight offsets in time delay between the output of the dipole loudspeaker 420 and the output of the sealed loudspeaker 425. Such offsets can modify the shape of the directional loudspeaker's 415 cardioid polar response 460, resulting in varying degrees of sub-cardioid (wide cardioid) or hypercardioid responses. Such modifications of the output of the directional loudspeaker's 415 represent potential tradeoffs in some applications where, for example, increased directionality is desirable at the expense of increased off-axis irregularities.

The output of the time delay circuit 520 is received by the power amplifier 525 for the sealed loudspeaker 425. The power amplifier 525 outputs an electrical signal to the driver of the sealed loudspeaker 425 that governs the sound output of the sealed loudspeaker 425. In one embodiment, the power amplifier 525, when connected to the sealed loudspeaker 425, is adjusted to implement an acoustical unitary gain.

Similar to the high-pass equalizer 510 for the sealed loudspeaker 510, the high-pass equalizer 530 for the dipole loudspeaker 420 performs comprises means for filtering electrical signals to filter out low-frequency components of the signal received from the microphone output processing module 505 and transmits the filtered version to the an all-pass filter 535 for the dipole loudspeaker 425. The high-pass equalizer 530 is designed to match the cumulative high-pass characteristics of the sealed loudspeaker 425, including those that are due to the enclosure 430 and those due to the associated electrical high-pass equalizer 510.

The bass-boost circuit 535 receives the output of the high pass equalizer 530 for the dipole speaker 420. The bass-boost circuit 535 comprises means for increasing the output of the dipole loudspeaker 420 at low frequencies in order to match the frequency response of the dipole loudspeaker 420 to that of the sealed loudspeaker as described above in reference to FIG. 4C. A number of means and techniques for bass-boosting a dipole loudspeaker 420 can be used and the present invention is not limited to any particular bass-boosting means or technique.

The bass-boost circuit 535 outputs an electrical signal to the all-pass filter 540 for the dipole loudspeaker 420. The all-pass filter 540, time delay circuit 545, and power amplifier 550 for the dipole loudspeaker 420 comprise similar signal processing means and perform similar signal processing functions as the all-pass filter 515, time delay circuit 520, and power amplifier 525 for the sealed loudspeaker 420.

It is important to note that although FIG. 5 subdivides the signal processing module 410 into distinct modules 505, 510, 515, 520, 525, 530, 535, 540, 545, 550 according to particular signal processing functions, these divisions are purely for the sake of illustrative clarity. Accordingly, the signal processing functions described herein can be performed by any appropriate means, including electronic circuitry that comprises any number of discrete components, integrated circuits, printed circuit boards, or the like or other signal processing means, including either purely analog circuitry or a digital signal processor or a firmware circuit. Similarly, although FIGS. 4A and 4B depict cell 305 embodiments that comprise a sole signal processing module 410 responsible for all signal processing functions within the individual cell 305, it is to be appreciated this is purely for illustrative clarity and that other embodiments can include of any number of signal processing modules 410. For example, in an alternative embodiment, each cell 305 includes distributed signal processing means that are collocated with one or more of the microphone 405, the sealed loudspeaker 425, and each dipole loudspeaker 420. The distributed signal processing means combine to perform the signal processing functions described herein.

In some embodiments, the signal processing module 410 is a purely analog system that comprises only analog processing means (i.e., the signal processing module 410 performs signal processing in the analog domain, without analog-to-digital conversion of any signal). Where signal processing is in the digital domain, the microphone processing module 505 includes an analog to digital converter (not shown) to convert the incoming signals from the microphone into the digital domain; a digital to analog converter (not shown) is used to convert the processed signals back to the analog domain prior to amplification.

The spacing between individual cells 305 can vary depending on the particular embodiment. In some embodiments, the distance between cells 305 may be sufficiently small that undesirable crosstalk can occur. As used herein, crosstalk refers to the microphone 405 of a first cell 305 sensing the output of the directional loudspeaker 415 of a second cell 305. FIG. 6 illustrates on embodiment of an array 210 of cells 305 configured to provide crosstalk cancellation. The system of FIG. 6 comprises a first cell 305w, a second cell 305x, a third cell 305y, and a fourth cell 305z. In addition to the features described above, each cell 305 comprises a crosstalk cancellation module 605. For the sake of illustrative clarity, only the microphone output processing module 505 and crosstalk cancellation module 605 of each cell 305 is shown.

One embodiment of crosstalk cancellation can be understood by examining the operation of the third cell 305y of FIG. 6. The microphone output processing module 505y of the third cell 305y receives (i) a crosstalk cancellation signal 610x from the second cell 305x and (ii) a crosstalk cancellation signal 610z from the fourth cell 305z. The crosstalk cancellation signal 610x represents an inverted, equalized, and time-delayed version of a signal 615x output by the microphone output processing module 505x of the second cell 305x. Similarly, the crosstalk cancellation signal 610z represents an inverted, equalized, and time-delayed version of a signal 615z output by the microphone output processing module 505z of the fourth cell 305z.

Conceptually, a first relationship exists between the signal 615x generated by the microphone output processing module 505x of the second cell 305x and the output of the directional loudspeaker 415x of the second cell 305x. This first relationship is based on the characteristics of the signal processing module 410x of the second cell 305x. A second relationship exists between the output of the directional loudspeaker 415x of the second cell 305x and the effect of this output upon the microphone 405y of the third cell 305y. This second relationship is based on the physical distance and propagation medium separating the cells 305x, 305y. Thus, in addition to processing the electrical signal output by the microphone 405y of the third cell as described above in reference to FIG. 5, the microphone output processing module 505y of the third cell 305y can negate the influence of any output of the directional loudspeaker 415x of the second cell 305x based on (i) the information represented by the received crosstalk cancellation signal 610x and (ii) the above-described first and second relationships. The microphone output processing module 505y of the third cell 305y can similarly negate the influence of any output of the directional loudspeaker 415z of the fourth cell 305z based on (i) the information represented by the received crosstalk cancellation signal 610z and (ii) the above-described first and second relationships as applied to the fourth cell 305z and the third cell 305y.

The microphone output processing module 505y of the third cell 305y also transmits a signal 615y, based on the output of its microphone 405y, to the crosstalk cancellation module 605y of the third cell 305. The crosstalk cancellation module 605y generates a corresponding crosstalk cancellation signal 610y comprising an inverted, equalized, and time-delayed version of this signal 615y. Thus, just as the microphone output processing module 505y of the third cell 305y receives crosstalk cancellation signals 610x, 610z from the neighboring cells 305x, 305z, the microphone output processing modules 505x, 505z of the second cell 305x and the fourth cell 305z receive crosstalk cancellation signals 610y from the second cell 305y.

The crosstalk cancellation module 605y comprises signal processing means (e.g., electric circuits) including equalization means, signal inversion means, and signal propagation delay means. The inversion means are configured to ensure that the crosstalk cancellation signal output 610y output by the crosstalk cancellation module 605y is opposite in polarity to the signal generated by the associated microphone output processing module 505y, allowing for eventual negation of any effect upon surrounding cells 305x, 305z of the corresponding sound generated by the directional loudspeaker 415y. The equalization means are configured to adjust the crosstalk cancellation signal 610y based on computable effects that the signal processing module 410y and the distance between cells 305 (e.g., associated noise attenuation) will have upon the extent of any undesired crosstalk. The signal propagation delay means are configured to compensate for the time delay between generation of sound by a neighboring cell 305x, 305z and reception of that sound by the microphone 405y. A number of techniques for calibrating and implementing the above-described equalization means, signal inversion means, and signal propagation delay means using signal processing techniques and hardware (e.g., electric circuitry) based the particular properties and layout of an embodiment of the present invention can be used.

As illustrated by FIG. 6, the second cell 305x implements crosstalk cancellation with regards to the first cell 305w and the third cell 305y in the same manner that the third cell 305x implements crosstalk cancellation with regards to the second cell 305x and the fourth cell 305z. Further, though the embodiment of FIG. 6 is a linear array 210 of four cells 305w, 305x, 305y, 305z, the crosstalk cancellation principles and implementations described in reference to FIG. 6 equally apply to an array 210 comprising any number or physical layout of cells 305. Also, the principles and implementations described in reference to FIG. 6 are scalable, and are not limited solely to providing crosstalk cancellation for immediately adjacent cells 305 within an array 210. For example, the second cell 305 could implement crosstalk cancellation with respect to both the third cell 305y and the fourth cell 305z, as well as any number of other cells 305. In one embodiment, the functions ascribed herein to the crosstalk cancellation module 605 of a cell 305 (e.g., signal equalization, signal inversion means, and signal propagation delay) are implemented within one or more microphone output processing modules 505 within the array 210.

### Exemplary Applications

The principles and design parameters of the present invention support a large variety of different applications for open air noise cancellation. Several non-limiting examples are now described.

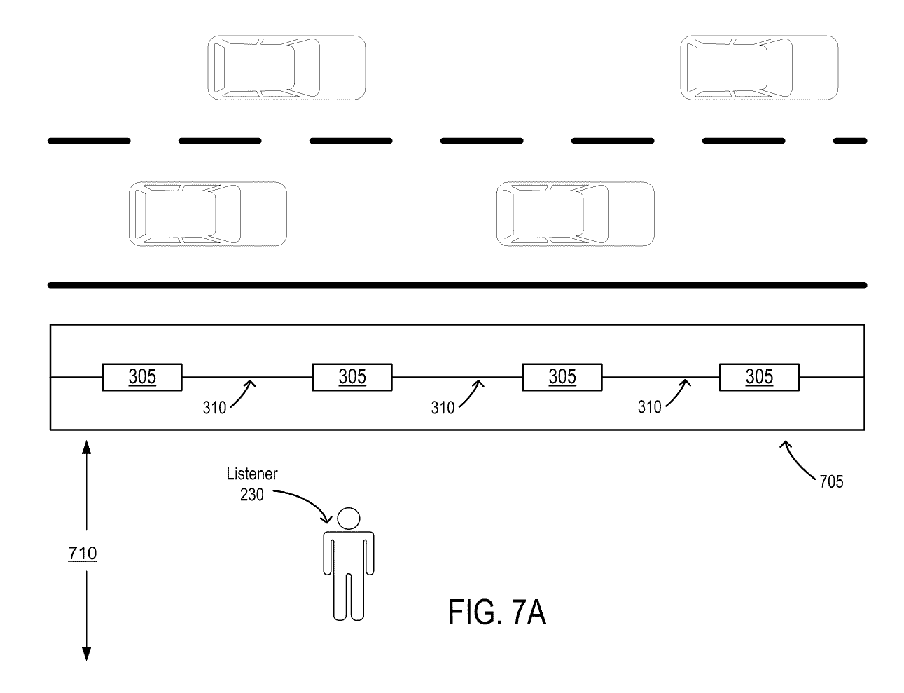

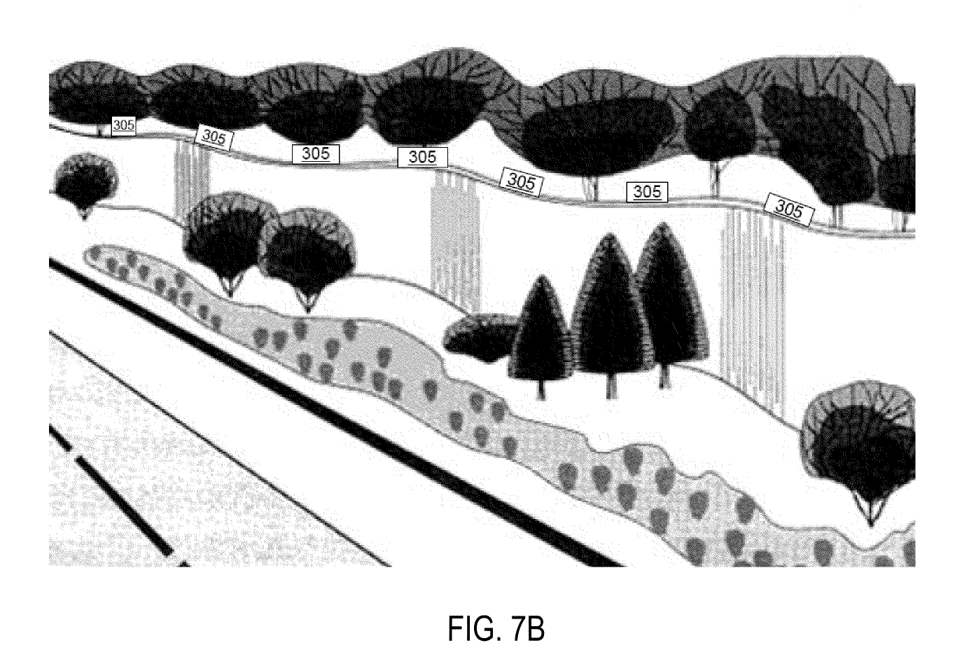

FIG. 7A shows one embodiment of a system employing open air noise cancellation in accordance with the present invention. A noise cancellation array 210 comprising plurality of cells 305 is positioned alongside a busy roadway. The cells 305 therefore provide active noise cancellation of roadway noise from the perspective of a location on the opposite side of the cells 305 from the roadway, such as street, office complex, or residential area. In one embodiment, the cells 305 are mounted atop a wall, such as a highway sound barrier wall 705; FIG. 7B illustrates a perspective view of such an installation. The highway sound barrier wall 705 can be constructed of any suitable material such as concrete or masonry. The cells 305 can be communicatively coupled by interconnections 310, and the interconnections can provide power to each cell 305 and/or transmit signals such as crosstalk cancellation signals 610 between one or more cells 305. In other embodiments, a cell 305 can operate as an autonomous unit powered by an attached photovoltaic cell or other means for harvesting ambient energy, as described above in reference to FIG. 3.

An array 210 of open air active noise cancellation cells 305 is particularly well-suited for placement on top of a wall such as the highway sound barrier wall 705. All sound perceived in the cancellation area 710 on the opposite side of the highway sound barrier wall 705 from the roadway results from sound diffracting around the top edge of the wall 705. The offending sound therefore actually comprises a line source coinciding with the top edge of the wall 705. Indeed, an acoustical field analysis would show the offending source to be the top edge of the wall 705, not the cars on the roadway. Because the wall 705 converts the offending noise to a linear source localized along its top edge, an array 210 of cells 305 atop the wall 705 provides an effective and elegant active noise cancellation solution for listeners 230 in the cancellation area 710.

The principles of cell 305 design described above in reference to FIGS. 4A-5 can be applied to design cells 305 of various size and ruggedness as needed for a particular application. For example, in a system such as that depicted in FIG. 7A, cells 305 comprise components such as microphones 405, signal processing means, and directional loudspeakers 415 that are of an appropriately industrial nature (e.g., designed for outdoor applications) for the particular deployment location. Similarly, cell 305 components, such as speaker drivers for the direction loudspeaker 415, are chosen such that they, due to either size or quantity, and along with suitable amplification, are capable of producing outputs with sound pressure levels capable of cancelling or reducing the offending noise (e.g., traffic noise) to a desired extent.

A system such as that of FIG. 7A allows the highway sound barrier wall 705 to be of smaller physical dimensions, to be constructed of less expensive materials, or to be altogether unnecessary, thereby reducing construction costs. For example, a hard sound wall (e.g., concrete) may be replaced entirely by a large two-dimensional array or grid of cells positioned like a curtain between the roadway and the desired cancellation area. Because of its lightweight nature, such an embodiment can be quickly installed and removed, making it particularly suited for temporary installation, for example at construction sites. Other applications for an open air noise cancellation system similar to that depicted in FIG. 7 include deployments near airports, factories, or other large-scale producers of undesirable noise. Also, though FIG. 7 depicts cells 305 deployed so as to keep sound from escaping an offensive noise source (e.g., the roadway), cells 305 can also be deployed so as to keep sound from penetrating a cancellation area (e.g., cells 305 can be deployed so as to surround a residence or other location).

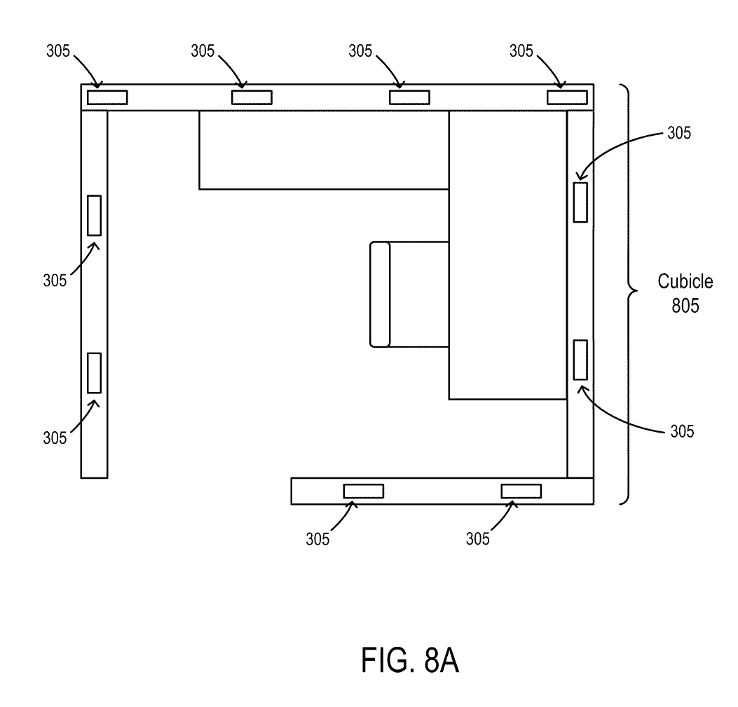

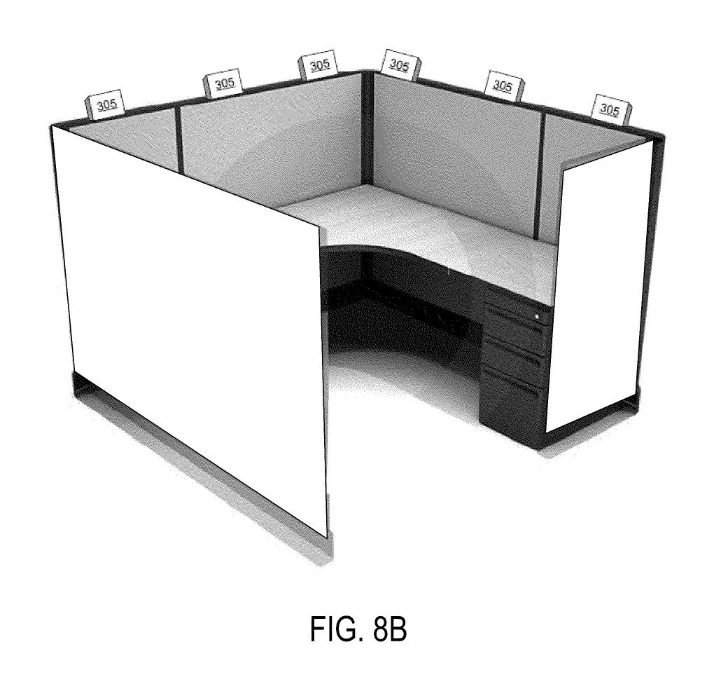

FIGS. 8A and 8B show another embodiment of a system employing open air noise cancellation in accordance with the present invention. FIGS. 8A and 8B illustrate a cubicle 805 whose outer walls are rimmed with open air noise cancellation cells 305 in accordance with the present invention. Out of privacy concerns, the cells 305 can be oriented so as to actively cancel any noise generated within the cubicle 805 from the perspective of any location outside the cubicle 805; the areas outside of a given cubicle 805 (e.g., other cubicles, walkways, etc.) can therefore be the cancellation area. The cells 305 can also be oriented so as to actively cancel any noise generated outside the cubicle 805 from the perspective of any location inside the cubicle 805, preventing a cubicle 805 occupant from suffering any annoyances caused by outside noises. The cells 305 can be sized, powered, and interconnected as otherwise described herein depending upon the needs of the particular deployment.

Further, though FIGS. 8A and 8B depict applications of open air noise cancellation to a cubicle 805, analogous applications are possible for restaurant booths or any other enclosure having a limited height wall that does not reach entirely to the ceiling. Also, though FIGS. 8A and 8B depict a two-dimensional array 210 of open air noise cancellation cells 305, the principles described herein allow for three-dimensional arrays 210 of open air noise cancellation cells 305. For example, rather than locating cells 305 atop the walls of a cubicle 805, cells 305 can be mounted within the walls, doors, and ceiling of a fixed office, break room, equipment room, or any other enclosure to prevent undesired noise from escaping or penetrating the enclosure. Similarly, cells 305 can be arranged in a window frame to cancel any outside noises.

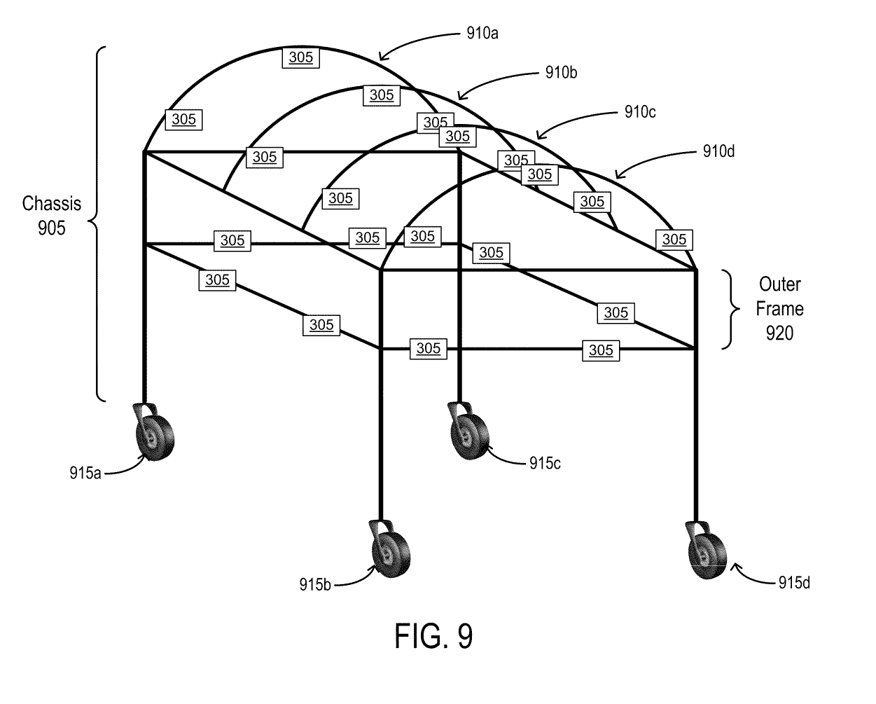

FIG. 9 shows another embodiment of an apparatus employing open air noise cancellation in accordance with the present invention. The apparatus of FIG. 9 comprises a chassis 905 that can be positioned such that it surrounds an offending noise source. The chassis 905 can be constructed of metal, plastic, or any other suitable material. The chassis comprises a plurality of arches 910 or similar supporting members over the area surrounded by an outer frame 920. In some embodiments, the chassis 905 is mounted on a plurality of wheels 915a or casters such that it is easily moved. In accordance with the principles described herein, a plurality of noise-cancellation cells 305 are mounted via mounting means to the chassis 905, for example along the arches 910 and the outer frame 920. The cells 305 are located and oriented such that noise from an offending source that is surrounded by the chassis 905 is actively cancelled from the perspective of any location outside of the chassis 905, which becomes the cancellation area. For example, the chassis 905 can also be positioned over loud machinery (e.g., an electric generator) to ensure compliance with noise-related safety requirements or to minimize noise-related disturbances that would otherwise be caused by the machine.

Alternatively, the apparatus of FIG. 9 can be configured so that area under the chassis 905 is the cancellation area, and thus noise from outside of the chassis 905 is blocked. One embodiment of this configuration is for blocking noise in neonatal care units. Here, the chassis 905 would be positioned over an infant resting area, such as a neonatal crib in a hospital, so that outside noises, such as noises from equipment, staff or the cries of other infants in the area do not disturb an infant in the crib beneath the chassis 905. Different embodiments of the chassis 905 can comprise different sizes and quantities of members allowing for highly-customizable cell 305 placements in three dimensions.

### Additional Considerations

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative designs for a system for providing open air noise cancellation through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. An apparatus for actively cancelling an ambient sound wavefront in an open air environment, the apparatus comprising:
a directional microphone having a first polar response, the directional microphone configured to, in response to a portion of the ambient sound wavefront being incident upon the directional microphone, produce a microphone output signal representative of the portion of the ambient sound wavefront;
a directional loudspeaker having a second polar response, the directional loudspeaker positioned behind the microphone such that the first polar response and the second polar response are opposite in orientation; and
a signal processing module configured to receive the microphone output signal from the directional microphone and transmit a control signal to the directional loudspeaker, the control signal causing the directional loudspeaker to produce a noise cancellation wavefront, wherein the noise cancellation wavefront and the ambient sound wave are equal in magnitude and inverse in polarity.

2. The apparatus of claim 1, wherein the directional loudspeaker comprises:
a first loudspeaker, the first loudspeaker having a dipole polar response;
a second loudspeaker, the second loudspeaker having an omnidirectional polar response; and
a baffle, the first loudspeaker and the second speaker mounted on the baffle such that the first loudspeaker and the second speaker open towards a common acoustic half space.

3. The apparatus of claim 2, wherein the second loudspeaker is a sealed loudspeaker comprising:
a driver; and
an enclosure having an internal air volume, the internal air volume and the driver forming a mechanical high-pass filter.

4. The apparatus of claim 2, wherein the first loudspeaker is coincident with the second loudspeaker.

5. The apparatus of claim 2, wherein the first loudspeaker is bass-boosted.

6. The apparatus of claim 2, wherein the directional loudspeaker further comprises a third loudspeaker, the third loudspeaker having a dipole polar response, and mounted on the baffle such that:
the first loudspeaker, the second loudspeaker, and the third loudspeaker are substantially collinear; and
the second loudspeaker is between the first loudspeaker and the third loudspeaker on the baffle.

7. The apparatus of claim 1, wherein:
the directional microphone and the directional loudspeaker are laterally separated by a distance;
the control signal further causes the directional loudspeaker to produce the noise cancellation wavefront a fixed time after the portion of the ambient sound wavefront is incident upon the directional microphone, wherein the fixed time is proportional to the distance.

8. A system for actively cancelling an ambient sound wavefront in an open air environment, the system comprising:
a plurality of noise cancellation devices arranged in an array, wherein each noise cancellation device comprises:
a directional microphone having a first polar response, the directional microphone configured to, in response to a portion of the ambient sound wavefront being incident upon the directional microphone, produce a microphone output signal representative of the portion of the ambient sound wavefront;
a directional loudspeaker having a second polar response, the directional loudspeaker positioned behind the microphone such that the first polar response and the second polar response are opposite in orientation; and
a signal processing module configured to receive the microphone output signal from the directional microphone and to transmit a control signal to the directional loudspeaker such that the directional loudspeaker produces a noise cancellation wavefront, wherein the noise cancellation wavefront and the ambient sound wavefront are equal in magnitude and inverse in polarity.

9. The system of claim 8, wherein the plurality of noise cancellation wavefronts produced by the plurality of noise cancellation devices of the array combine to actively cancel the ambient sound wavefront in accordance with the Huygens principle.

10. The system of claim 8 wherein the noise cancellation devices are spaced unevenly within the array.

11. The system of claim 8, wherein the plurality of noise cancellation devices are arranged as a line array.

12. The system of claim 8, wherein the plurality of noise cancellation devices are arranged as a spatial array.

13. The system of claim 8, wherein each noise cancellation device further comprises crosstalk cancellation means, the crosstalk cancellation means comprising:
means for receiving a cross-talk cancellation signal from a neighboring cell, the cross-talk cancellation signal representative of sound produced by the neighboring noise cancellation device; and
means for altering the microphone output signal based on the cross-talk cancellation signal.

14. The system of claim 8, wherein each noise cancellation device further comprises crosstalk cancellation means configured to generate a crosstalk cancellation signal, the crosstalk cancellation signal comprising a time-delayed and polarity-inverted version of the microphone output signal.

15. The system of claim 8, wherein the plurality of noise cancellation devices are arranged on top of a wall.

16. The system of claim 8, wherein:
the plurality of noise cancellation devices are mounted to a chassis; and
the chassis comprises a three-dimensional structure for surrounding a noise source.

17. The system of claim 8, wherein the directional loudspeaker comprises:
a first loudspeaker, the first loudspeaker having a dipole polar response;
a second loudspeaker, the second loudspeaker having an omnidirectional polar response; and
a baffle, the first loudspeaker and the second speaker mounted on the baffle such that the first loudspeaker and the second speaker open towards a common acoustic half space.

18. The system of claim 17, wherein the second loudspeaker is a sealed loudspeaker comprising:
a driver; and
an enclosure having an internal air volume, the internal air volume and the driver forming a mechanical high-pass filter.

19. The system of claim 17, wherein the first loudspeaker is coincident with the second loudspeaker.

20. The system of claim 17, wherein the first loudspeaker is bass-boosted.

21. The system of claim 17, wherein the directional loudspeaker further comprises a third loudspeaker, the third loudspeaker having a dipole polar response, and mounted on the baffle such that:
the first loudspeaker, the second loudspeaker, and the third loudspeaker are substantially collinear; and
the second loudspeaker is between the first loudspeaker and the third loudspeaker on the baffle.

22. The system of claim 17, wherein:
the directional microphone and the directional loudspeaker are laterally separated by a distance;
the control signal further causes the directional loudspeaker to produce the noise cancellation sound wave a fixed time after the directional microphone receives the ambient sound wave, where the fixed time is proportional to the distance.
